(19) United States
(12) Patent Application Publication
(10) Pub. No.: US 2016/0378789 A1
(43) Pub. Date: Dec. 29, 2016

(54) SYSTEM AND METHOD FOR GLOBAL OBJECT RECOGNITION

(71) Applicant: Raytheon Company, Waltham, MA (US)

(72) Inventors: Paul C. Hershey, Ashburn, VA (US); Michael P. Sica, Oak Hill, VA (US); Jason Dudash, Arlington, VA (US); Christopher J. Graham, Bethesda, MD (US)

(21) Appl. No.: 14/809,352

(22) Filed: Jul. 27, 2015

Related U.S. Application Data
(60) Provisional application No. 62/028,927, filed on Jul. 25, 2014.

(51) Int. Cl. G06F 17/30

(52) U.S. Cl. CPC G06F 17/30256; G06F 17/30241; G06F 17/30277

(57) ABSTRACT

A global object detection server reduces the amount of time needed to determine whether an object is present in a collection of images for a geographic area. In particular, the disclosed global object detection server selects one or more object recognition algorithms from a collection of algorithms based on one or more characteristics of the object to be detected. The algorithm results may then be fed back to reduce input data sets from iterative collections for similar regions. The global object detection server can also derive stochastic probabilities for object detection accuracy. Thereafter, one or more visualizations may be created that show confidence levels for the object's probable location in the collection of images.

### RELATED APPLICATIONS

This application claims the priority benefit of U.S. Provisional Application No. 62/028,927, entitled “MIDATA APPLICATION TO LOCAL/REGIONAL/GLOBAL JOINED OBJECT RECOGNITION (MAJOR),” filed Jul. 25, 2014, which is hereby incorporated herein by reference in its entirety.

### TECHNICAL FIELD

The present application relates generally to the technical field of image recognition, and, in various embodiments, to systems and methods of formulating an algorithmic processing path and, in particular, an algorithmic processing path that includes image-recognition algorithms for processing geographic images and/or full-motion video imagery to locate an object having a particular set of characteristics.

### BACKGROUND

Past events demonstrate a desire for technologies that provide timely identification and geo-location of objects lost within a vast geographic area covering thousands of square kilometers over both land and water.

As one example, on May 8, 2014, a Malaysian Boeing 777-200ER airliner, traveling from Kuala Lumpur to Beijing China, disappeared in flight. A massive search was conducted by multiple countries using advanced satellite, radar, and ISR (Intelligence, Surveillance and Reconnaissance) technologies. However, the airliner was not located within the first two weeks of its disappearance. During this two week period, over 3 million people, both military and civilians, reviewed over 257 million images covering 24,000 sq. kms., including land and water-based images. Even with this manpower and technology, the missing airliner could not be located.

Conventionally, analysts use advanced satellite, radar, and ISR capabilities to collect mission data, but then spend significant time and resources processing this data to extract relevant information. Corporations that are involved in the processing of large data sets (conventionally known as “Big Data”) are working on the problem but do not have a viable or timely solution for finding an arbitrary object in an unspecified geographical area.

Another approach for analyzing millions of images is to use crowd sourcing via the Internet. However, this approach has drawbacks as well, such as accessibility to up-to-date satellite imagery, lack of training, and the potential for false reporting and Denial of Service (DoS) cyberattacks.

Yet a further approach to locating objects in diverse geographical areas is to use traditional ISR techniques. These techniques include using Unmanned Air Systems (UXS) for air, surface, subsurface scanning and image acquisition. However, these techniques also have their drawbacks in that they are typically associated with high costs, a short search time, difficulties in relevancy (e.g., the unmanned aerial vehicle must be in the right area at right time), and they require large communication bandwidths to send imagery data to a ground station for processing.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating the components of a global object recognition server illustrated in FIG. 1, according to an example embodiment.

FIG. 3 is a block diagram illustrating a process flow of the global object recognition server in performing object recognition according to an example embodiment.

FIG. 4 is a block diagram illustrating various image recognition algorithms, according to an example embodiment, employed by the global object recognition server.

FIG. 5 illustrates a method, according to an example embodiment, for performing object recognition by the global image recognition server.

FIG. 6 illustrates a graph demonstrating the reduced processing time obtained by the global object recognition server.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The following disclosure provides systems and methods for rapidly screening large collections of sensor images (e.g., digital photographs, image frames extracted from full motion video, etc.) to extract elements of information (EIs) that facilitate the transformation of raw data into actionable information from which analysts can locate lost objects in arbitrary geographic locations within a reduced time frame compared to present methods (e.g., weeks to hours or minutes).

In one embodiment, the disclosed systems use a context sensitive, event detection algorithm to identify and select object recognition algorithms to achieve object recognition time reduction. Thereafter, these algorithms are executed on one or more processors, such as central processing units (CPUs) and/or graphical processing units (GPUs), depending on a given algorithm's processing requirements. The results from the application of a selected algorithm is then fed back into the selection process to reduce input data sets from iterative collections in similar regions.

To reduce the amount of time required in performing objection recognition, a processing workload may be intelligently (e.g., selectively) divided among a selected number of processing nodes (e.g., 1 to N processing nodes, where N is a whole number). The systems and methods may also include tagging to support automatic metadata associations. Based on the results from the image-processing algorithms, the systems and methods then derive stochastic probabilities for object detection accuracy.

Thereafter, the systems and methods create one or more visualizations showing confidence levels for probable object location for a given set of parameters. The probability output results may then be fed into a planner for organizing the search of the missing object(s).

In one embodiment, still imagery and full-motion video imagery may be retrieved and processed from one or more databases to locate a particular object. Various characteristics of the object may be defined based on one or more metadata parameters. The metadata may be used in conjunction with a search context to select one or more algorithm(s) to perform the object recognition. For example, the system may contain an algorithm metadata catalog, which may contain characteristics for one or more the image processing algorithms.

Examples of metadata may include, but are not limited to: characterizing performance (e.g., Big-O), memory requirements, estimated runtime for various input resolutions and sample counts, geographic dimension applicability (land vs water or both), functional type applicability (building, car, person), and other such defined metadata parameters. By representing algorithm characteristics in metadata, the system dynamically and autonomously creates a chaining solution to facilitate the identification of a missing object.

As the various algorithms may leverage different input parameters, the disclosed systems and methods define a common application programming interfaces (“APIs”) for the algorithms. The systems and methods may then build multi-path algorithm chains to increase overall processing speed by reducing input data sets. In one embodiment, optimal path selection options may include automatically building the multi-path algorithm chain based on a context, manually building the multi-path algorithm chain based on user input, or combinations thereof. Results from the processing of the geographic images include, but is not limited to a probability of object detection and associated confidence intervals, changes in probability of an object being located at a given geographic over time, and other such results.

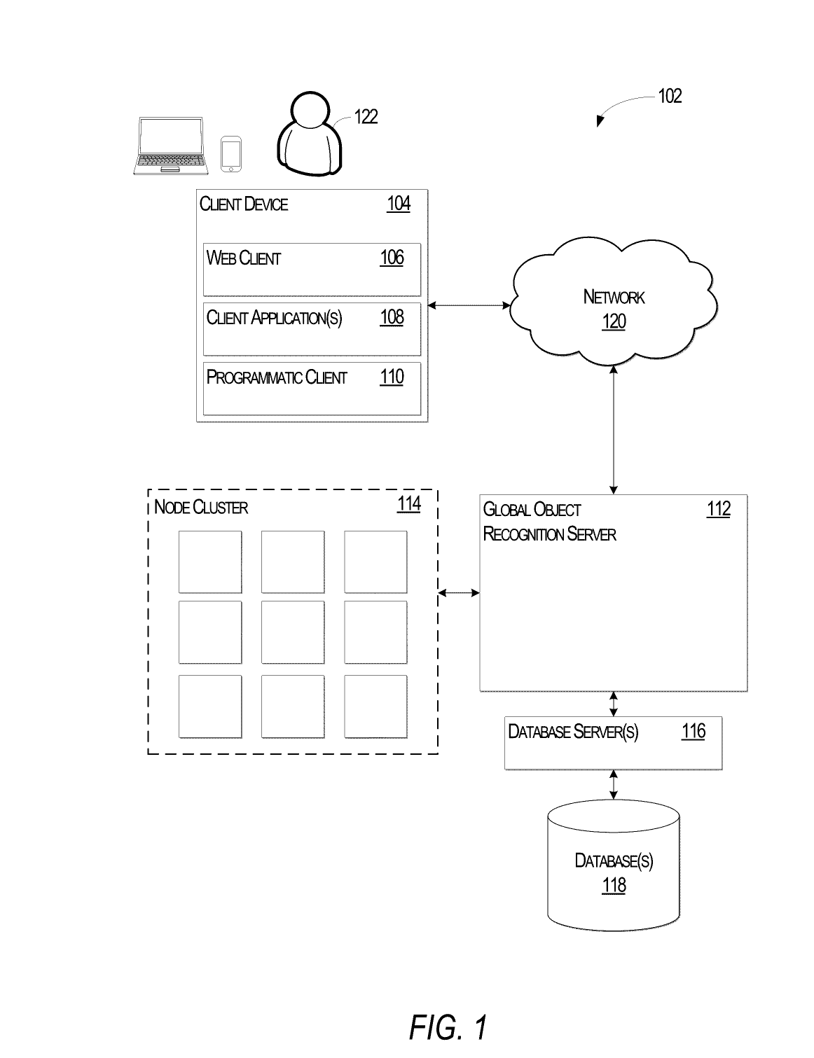

With reference to FIG. 1, an example embodiment of a high-level client-server-based network architecture 102 is shown. A global object recognition server 112 provides server-side functionality via a network 120 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), an application 108, and a programmatic client 110 executing on client device 104. The global object recognition server 112 further communicates with a node cluster 114 that includes one or more network nodes and one or more database servers 116 that provide access to one or more databases 118.

The client device 104 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, or any other communication device that a user may utilize to access the global object recognition server 112. In some embodiments, the client device 104 may comprise a display module (not shown) to display information (e.g., in the form of user interfaces). In further embodiments, the client device 104 may comprise one or more of a touch screens, accelerometers, gyroscopes, cameras, microphones, global positioning system (GPS) devices, and so forth. The client device 104 may be a device of a user that is used to perform a transaction involving digital items within the global object recognition server 112. In one embodiment, the global object recognition server 112 is a network-based appliance that responds to requests to find an object that may have been captured in one or more images (e.g., satellite images) or in one or more frames of a full-motion video. One or more users 122 may be a person, a machine, or other means of interacting with client device 104. In embodiments, the user 122 is not part of the network architecture 102, but may interact with the network architecture 102 via client device 104 or another means. For example, one or more portions of network 120 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 104 may include one or more applications (also referred to as “apps”) such as, but not limited to, a web browser, messaging application, electronic mail (email) application, a global object recognition server access client, and the like. In some embodiments, if the global object recognition server access client is included in a given one of the client device 104, then this application is configured to locally provide the user interface and at least some of the functionalities with the application configured to communicate with the global object recognition server 112, on an as needed basis, for data and/or processing capabilities not locally available (e.g., access to a database of items available for sale, to authenticate a user, to verify a method of payment, etc.). Conversely if the global object recognition server access client is not included in the client device 104, the client device 104 may use its web browser to access the search functionalities of the global object recognition server 112.

One or more users 122 may be a person, a machine, or other means of interacting with the client device 104. In example embodiments, the user 122 is not part of the network architecture 102, but may interact with the network architecture 102 via the client device 104 or other means. For instance, the user provides input (e.g., touch screen input or alphanumeric input) to the client device 104 and the input is communicated to the networked system 102 via the network 120. In this instance, the global object recognition server 112, in response to receiving the input from the user 122, communicates information to the client device 104 via the network 120 to be presented to the user 122. In this way, the user 122 can interact with the global object recognition server 112 using the client device 104.

Further, while the client-server-based network architecture 100 shown in FIG. 1 employs a client-server architecture, the present subject matter is of course not limited to such an architecture, and could equally well find application in a distributed, or peer-to-peer, architecture system, for example.

In addition to the client device 104, the global object recognition server 112 is communicatively coupled to a node cluster 114 and one or more database server(s) 116 and/or database(s) 118. In one embodiment, the node cluster 114 includes one or more loosely or tightly connected computers (e.g., network nodes) that work together so that, in many respects, the node cluster 114 is viewed as a single system. The nodes of the node cluster 114 may be connected through one or more communication mediums, such as Ethernet, fiber optic cable, etc., and form a local area networks (“LAN”), with each node running its own instance of an operating system. In some embodiments, each of the nodes of the node cluster 114. However, in alternative embodiments, the nodes may include different operating systems and/or different hardware. While the node cluster 114 is shown as a single cluster, one of ordinary skill in the art will appreciate that the node cluster 114 may include multiple clusters, which may be geographically disparate or local.

The global object recognition server 112 communicates with the node cluster 114 to assign object recognition processing tasks to the various individual nodes. Accordingly, each of the nodes include a client application for receiving the tasks from the global object recognition server 112 which, as discussed below, may include one or more image recognition algorithms to apply to one or more images. As the nodes of the node cluster 114 complete their assigned tasks, the nodes communicate their results to the global object recognition server 112, which then incorporates such results into a larger result set. In this manner, the global object recognition server 112 can use the node cluster 114 to complete object recognition and image processing tasks in a more efficient and expeditious way than it could if it were to perform the tasks itself. However, in some embodiments, the node cluster 114 is unavailable to the global object recognition server 112, in which case, the global object recognition server 112 performs the object recognition and image processing tasks itself.

The database server(s) 116 provide access to one or more image database(s) 118, which include satellite imagery of geographical locations. The global object recognition server 112 communicates with the database server(s) 116 to retrieve one or more images from the database(s) 118. In one embodiment, the global object recognition server 112 requests specific images from the database(s) 118. In another embodiment, the global object recognition server 112 requests images corresponding to one or more geographic locations (e.g., North America, Europe, the Middle East, etc.). In yet a further embodiment, the requests include latitude and longitude coordinates, which the database server(s) 118 then use to retrieve images corresponding to such latitude and longitude coordinates. Examples of organizations that provide access to such satellite imagery include the National Geospatial-Intelligence Agency, the United States Air Force Research Laboratory, TerraServer, and other such organizations. As discussed below, the retrieved images are then processed by the node cluster 114 and/or the global object recognition server 112 according to a set of object parameters to determine whether the retrieved images include the object being searched.

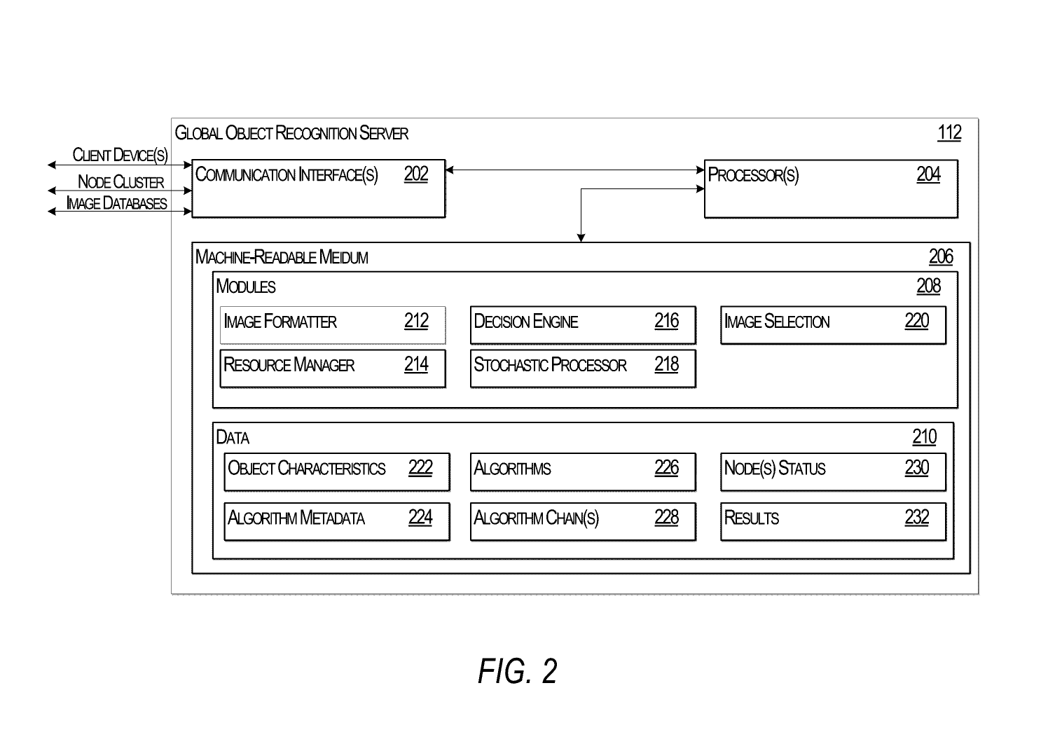

FIG. 2 is a block diagram illustrating the components of a global object recognition server 114 illustrated in FIG. 1, according to an example embodiment. In one embodiment, the global object recognition server 112 includes one more communication interfaces 202 in communication with one or more processors 204. The one or more processors 204 are communicatively coupled to one or more machine-readable mediums 206, which include modules 208 for implementing the disclosed global object recognition server 112 and data 210 to support the execution of the modules 208.

The various functional components of the global object recognition server 112 may reside on a single device or may be distributed across several computers in various arrangements. The various components of the global object recognition server 112 may, furthermore, access one or more databases (e.g., databases 118 or any of data 210), and each of the various components of the global object recognition server 112 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the global object recognition server 112 and the client device(s) 104, the node cluster 114, and one or more database server(s) 116 and/or database(s) 118. The one or more communication interfaces 202 may include one or more wired interfaces (e.g., an Ethernet interface, Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combination of such wired and wireless interfaces.

The machine-readable medium 206 includes various modules 208 and data 210 for implementing the disclosed global object recognition server 112. The machine-readable medium 206 includes one or more devices configured to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as a “cloud-based” storage systems or storage networks that include multiple storage apparatus or devices. As shown in FIG. 2, the machine-readable medium 206 excludes signals per se.

In one embodiment, the modules 208 are written in a computer-programming and/or scripting language. Examples of such languages include, but are not limited to, C, C++, C#, Java, JavaScript, Perl, Python, or any other computer programming and/or scripting language now known or later developed.

With reference to FIG. 1, the image selection module 220 is configured to retrieve one or more images from the databases 118. The images include various types of terrestrial imagery, such as land-based images, water-based images, or combinations thereof (e.g., images of beaches, lakefronts, etc.). Furthermore, the images may be of various types of satellite imagery including, but not limited to, visible imagery, infrared imagery, water vapor imagery, and near infrared imagery. The images may also be in various types of formats including, but not limited to, JPEG, GIF, PNG, BMP, TIFF, or other image format type now known or later developed.

To determine which images to retrieve from one or more of the databases 118, the image selection module 220 is provided with one or more context parameters that define a geographic search for an object to be located. The context parameters may include, but are not limited to, latitude coordinates, longitude coordinates, descriptive terms (e.g., “water,” “beach,” “mountain,”), proper nouns (e.g., “Japan,” “United States,” “California,” etc.), and other such parameters or combinations thereof. In one embodiment, the context parameters include a range of latitude coordinates and a range of longitude coordinates, which the image selection module 220 then provides to the database server(s) 116 to retrieve the corresponding images.

Furthermore, and in various embodiments, the image selection module 220 retrieves the one or more images from different databases 118. For example, the image selection module 220 may receive images of the same, or nearly the same, geographic location from a first image provider and a second image provider (or third, fourth, fifth, etc., image provider). While this implementation has the benefit of obtaining images from different sources (such as where the first image provider may have a different collection of images than a second image provider), this implementation also introduces the possibility of processing images of geographic locations that have already been processed. Accordingly, and as discussed below, as the global object recognition server 112 processes the retrieved images, the image selection module 220 is configured to remove redundant or irrelevant images from the image processing queue. The image selection module 220 may remove the redundant or irrelevant images by comparing timestamps (e.g., older images may be considered less relevant than newer images of the geographic location), metadata associated with the images (e.g., latitude and/or longitude coordinates associated with an image), and other such image parameters. In this manner, the image selection module 220 facilitates removing images from the image processing queue that may be redundant or irrelevant to the object search.

The modules 208 also include an image formatter 212 for formatting the retrieved images. As discussed above, the images obtained from the various databases 118 may be in different format types. Furthermore, the images may have different image characteristics, such as color spaces (e.g, 8-bit color, 16-bit color, etc.), different resolutions (e.g., 300 DPI, 700 DPI, etc.), different sizes (e.g., 1024×768, 640×480, etc.), or other such characteristics. Accordingly, the image formatter 212 is configured to format (e.g., normalize) the images to a canonical or standard format. For example, the images may be converted to a PNG format, with a resolution of 600 DPI, and a size of 1024×768. Of course, other formats and/or other image characteristics are also possible. Furthermore, such characteristics may be selectable by a user or preconfigured prior to execution of the object search.

The decision engine 216 is configured to determine which algorithms 226 to select and/or chain in processing the retrieved images. In one embodiment, the algorithms 226 are associated with corresponding algorithm metadata 224. Examples of algorithm metadata 224 include, but is not limited to, characterizing performance (e.g., Big-O), memory requirements, estimated runtime for various input resolutions and sample counts, geographic dimension applicability (land vs water or both), functional type applicability (building, car, person), and other such defined metadata parameters.

Prior to conducting the object search, a user provides the global object recognition server 112 with object characteristics 222 that describe the object being searched. For example, the user may provide whether the object is an airplane, boat, vehicle, building, the object's dimensions, whether the object is a complete or partial object, the type of object (e.g., model of airplane, boat, or vehicle), and other such characteristics. In conjunction with the previously provided context parameters, the decision engine 216 selects those algorithms 226 that best satisfy the object characteristics and the context parameters. Examples of algorithms 226 that are available for selection by the decision engine 216 include a geography detection algorithm that determines whether an image depicts a land-based image or a water-based image, a ship detection algorithm that determines whether a water-based image includes a ship, an advanced search protocol algorithm that determines whether a land-based image includes a vehicle and/or a building, and algorithms that identify a potential model of ship or vehicle depicted in a selected image. One of ordinary skill in the art will recognize that these algorithms are also used in conventional object searching techniques.

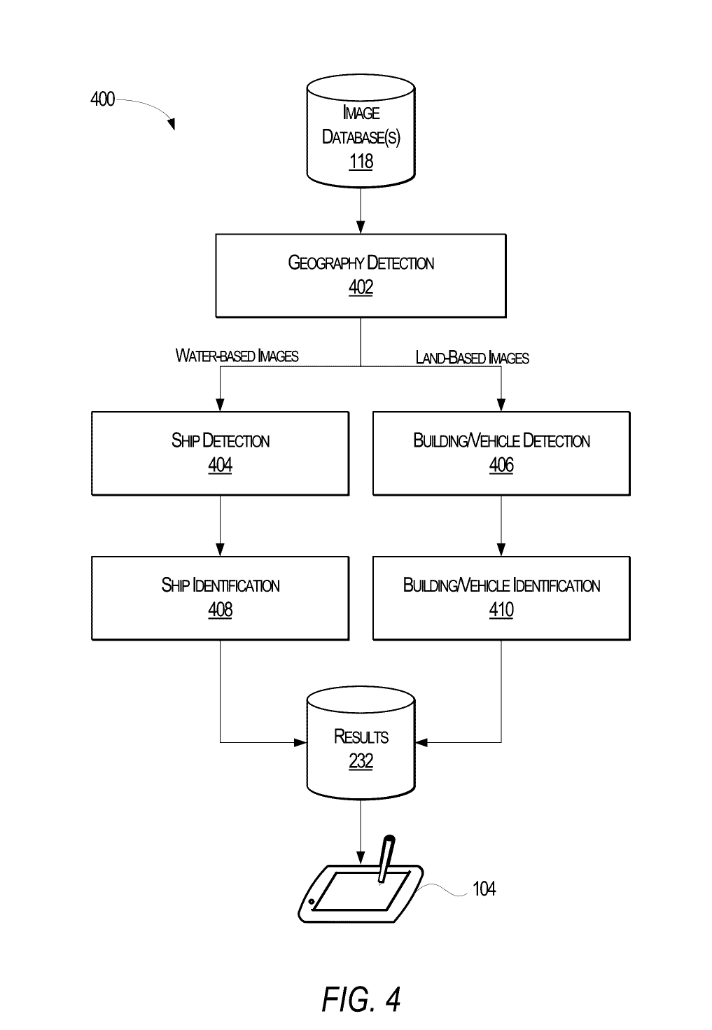

In addition, the decision engine 216 builds one or more algorithm chains 228 that indicate the order in which the algorithms 226 are to be executed, such as by the global object recognition server 112, the node cluster 114, or both. The decision engine 216 builds the algorithm chains 228 based on the previously provided context parameters and object characteristics. The decision engine 216 may build the algorithm chains 228 by comparing the algorithm metadata 224 with the provided object characteristics and context parameters. An example of an algorithm chain is discussed with reference to FIG. 4 further below.

The resource manager module 214 is configured to manage the resources and assets available to the global object recognition server 112, including the retrieved images, the selected algorithms, the one or more processors 204, and available nodes of the node cluster 214. In one embodiment, the data 210 includes a set of node status data 230 that informs the resource manager 214 of the status of a given node, such as whether the node is available, is processing an assigned image or images, has completed processing, or provides other such status information.

The resource manager module 214 is responsible for assigning algorithms and images to various nodes, and then incorporating the results of the processing performed by the nodes with a final result set. Accordingly, a network node may include a client application in communication with the resource manager module 214 for receiving new tasks and providing corresponding results. As results are received and/or obtained, the resource manager module 214 incorporates such results into the results data 232. In one embodiment, the results data 232 include images that have been identified as likely having an object matching one or more of the object characteristics previously provided. In addition, as images are processed, the resource manager 214 coordinates with the image selection module 220 to remove those images that were previously selected but would be redundant.

After obtaining the results 232, the stochastic processor 218 builds a visual layout of locations where the object being searched is likely to be located. Accordingly, the stochastic processor 218 implements one or more stochastic math models for analyzing the results 232 obtained by the resource manager 214. In one embodiment, the stochastic processor 218 generates a visualization, such as a heatmap, representing a plurality of locations where the object being searched is likely to be located based on the results 232. In another embodiment, the stochastic processor 218 builds a timeline of heatmaps that change over time, reflecting the changes in probability that the object being searched is likely to be located in a given location. Such changes include, but are not limited to, ocean currents that may cause an object to drift, earthquakes or volcanoes that may cause the object to move from one location to another, and other such phenomenon. The stochastic processor 218 could also be configured to account for man-made phenomena that may impact the location of an object being searched, such as conflicts, automotive traffic, ocean ship traffic, and other such man-made phenomena.

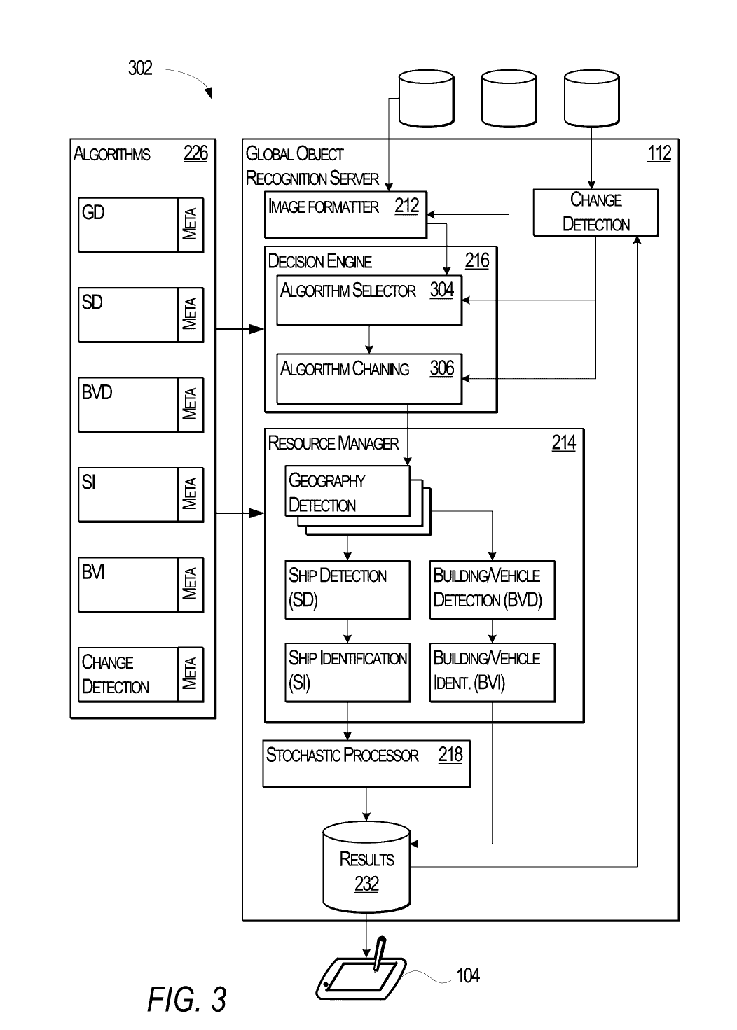

FIG. 3 is a block diagram illustrating a process flow 302 of the global object recognition server 112 in performing object recognition according to an example embodiment. As shown in FIG. 3, the image formatter 212 formats retrieved images according to a specified format (e.g., image type, size, resolution, color space, etc.). The formatted images are then communicated to the decision engine 216, which includes algorithm selection logic 304 and algorithm chaining logic 306. As discussed previously, one or more algorithms 226 may be selected and/or chained based on the previously provided context parameters and object characteristics.

After the algorithm chain(s) are formulated, the chain(s) and the retrieved images are communicated to the resource manager 214. The resource manager 214 then coordinates the image processing and object detection among the various assets available to the global object recognition server 112, including one or more local resources (e.g., hardware processors, memory, etc.) and/or networked resources (e.g., network nodes).

As the images are processed, the results of the processing may then be communicated to the stochastic processor 218. In one embodiment, results for water-based images are communicated to the stochastic processor 218 as the location of the object may change based on naturally occurring phenomenon (e.g., water currents). In another embodiment, results for land-based images are stored as part of the results 232 as there is a decreased likelihood that natural phenomenon would cause the object to move or change its location. In yet a further embodiment, whether the results from the resource manager 214 are provided to the stochastic processor 218 is configurable, such that a user of the client device 104 can indicate whether the results should be stochastically processed.

The global object recognition server 112 may also employ a change detection algorithm that is designed to retrieve images where the object is likely to be located based on the naturally occurring or man-made phenomenon. As shown in FIG. 3, the change detection algorithm may affect the images retrieved by the global object recognition server 112 and the algorithms selected and/or chained by the decision engine 216.

Visualizations of the results are then displayed on a display, such as the client device 104. As shown in FIG. 3, the client device 104 may be a tablet or other touch-sensitive device.

FIG. 4 is a block diagram 400 illustrating various image recognition algorithms 402-410, according to an example embodiment, employed by the global object recognition server 112. As shown in FIG. 4, the images retrieved from the image database(s) 118 may first undergo a geography detection algorithm 402 that classifies a retrieved image as either a water-based image (e.g., an image depicting an ocean, lake, bay, or other body of water) or a land-based image (e.g., land, an island, a peninsula, or other land mass).

Depending on whether the image is water-based or land-based, an a ship detection algorithm 404 or a building/vehicle detection algorithm 406 is executed on the image. The ship algorithm 404 is designed to determine whether the image includes an object that may be a ship. In contrast, the building/vehicle detection algorithm 406 is designed to determine whether the image includes an object that may be a vehicle or a building.

Thereafter, the results are then fed into a ship identification algorithm 408 or a building/vehicle identification algorithm 410. The algorithms 408-410 are designed to determine whether the object depicted in a given image could be specific to a given ship design or vehicle model and, if so, the possible ship design or vehicle model. Of course, during the processing of an image, should any of the algorithms 404-410 determine that the image does not include a ship, vehicle, or building (e.g., the object being searched), the algorithms 404-410 indicate that the image does not include such object and the next image would then be processed.

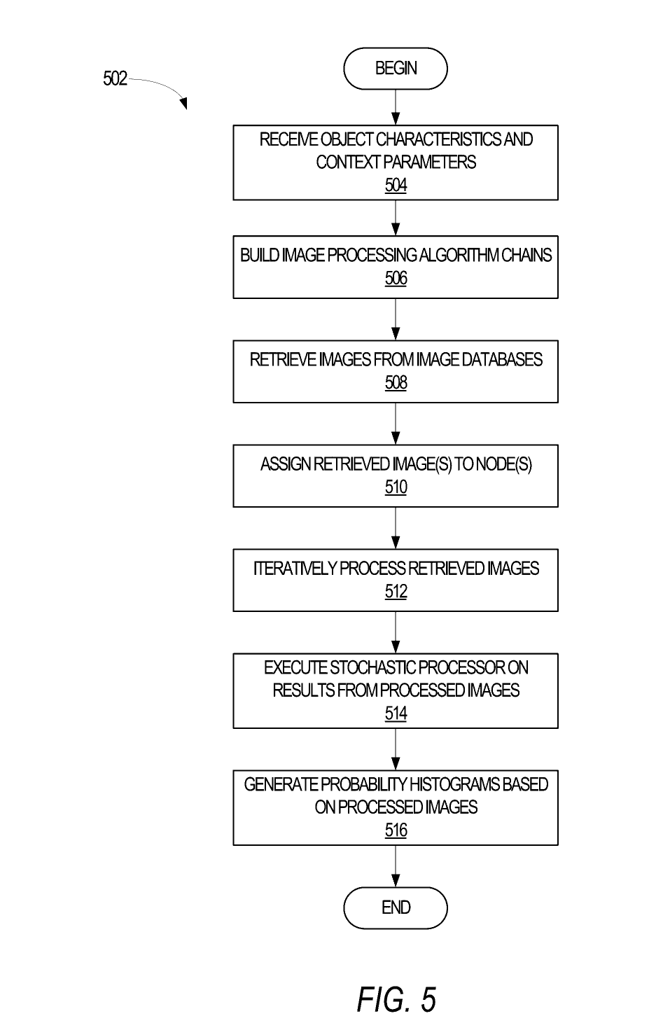

FIG. 5 illustrates a method 502, according to an example embodiment, for performing object recognition by the global image recognition server 112. The method 502 may be implemented by one or more components of the global object recognition server 112 and is described by way of reference thereto.

Initially, the global object recognition server 112 receives one or more context parameters that define a geographic search for an object to be located (Operation 504). As discussed above, examples of context parameters include a range of latitude coordinates and/or range of longitude coordinates, a description of where the search is to occur, proper nouns of places to include in the search, how long the search should last, when the object went missing, and other such context parameters. In addition, the global object recognition server 112 receives one or more object characteristics that define the object, such as its type, size, whether it is whole or in one or more portions, and other such characteristics.

The decision engine 216 then selects one or more algorithms 226 that are likely to satisfy the context parameters and/or object characteristics, and builds corresponding algorithm chains for processing satellite imagery (Operation 506). As discussed previously, such algorithms may include a geography detection algorithm, an ship detection algorithm, a building/vehicle detection algorithm, a change detection algorithm, and other such algorithms and processes.

The global image recognition server 112 then retrieves the geographic images from one or more of the image database(s) 118 (Operation 508). As discussed previously, as the images are retrieved, an image formatter module 212 formats the images to be in a canonical or standardized format. Thereafter, the resource manager 214 assigns the retrieved/formatted images to network nodes that are available to the global object recognition server 112 (Operation 510). Should there be no network nodes available, the resource manager 214 leverages assets local to the global object recognition server 112 for processing the retrieved and formatted images.

The assigned images are then processed by their corresponding network node and/or the global object recognition server 112 (Operation 512). As discussed above, processing the images include applying one or more algorithms 226 and/or algorithm chains 228 to the assigned images. In one embodiment, the resource manager 214 communicates the algorithm chain 228 to a network node for processing assigned one or more images. As the network node completes its assigned processing, it communicates the results to the network manager 214, which may then incorporate the results of such processing into the result data set 232.

After the one or more retrieved images have been processed and the results have been obtained, the global object recognition server 112 may then invoke the stochastic processor 218 to determine confidence values for one or more geographic locations for the processed images (Operation 514). As discussed above, and in one embodiment, the stochastic processor 218 generates a heatmap visualization of probabilities with corresponding locations where the object being searched is likely to be located (Operation 516). The heatmap visualization may then be displayed on the client device 104 or other display in communication with the global object recognition server 112.

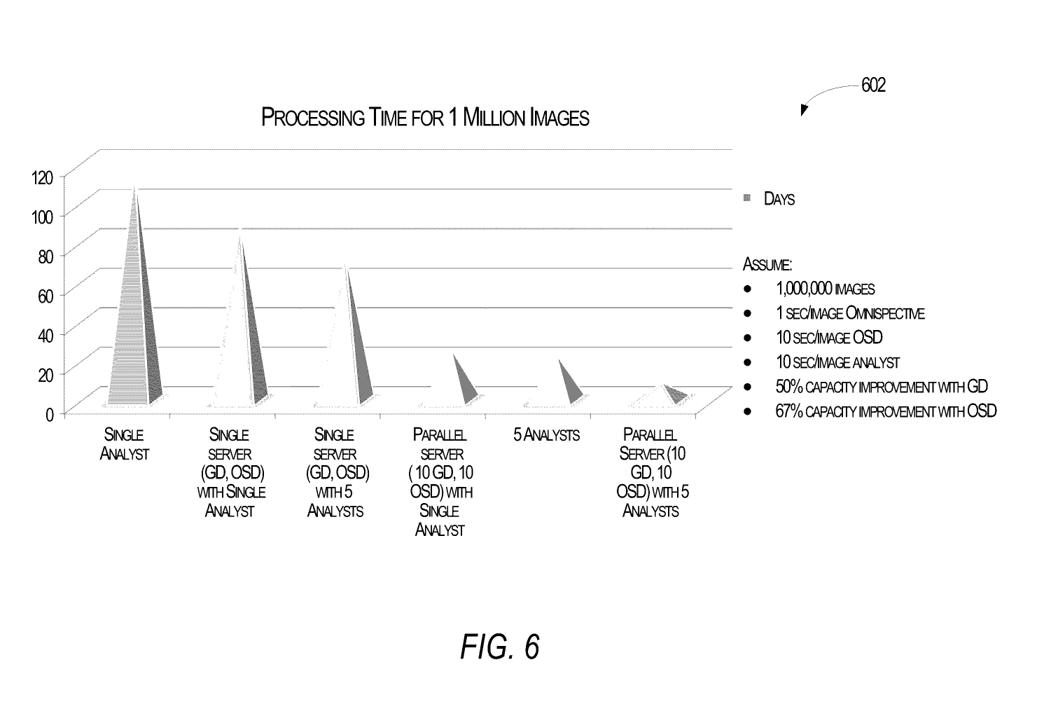

FIG. 6 illustrates a graph 602 demonstrating the reduced processing time obtained by the global object recognition server. As shown in FIG. 6, the processing time for processing approximately 1,000,000 images decreases significantly as the number of number of algorithms in use increases and the number of analysts involved in reviewing the results also increases. In FIG. 6, the fastest processing time is achieved when various image processing algorithms are executed in parallel and five analysts are involved in reviewing the results of such processing. The graph 602 clearly demonstrates that the techniques used by the global object recognition server 112 have a meaningful impact on the amount of time required to process a significant (e.g., non-trivial) number of images.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-Readable Medium

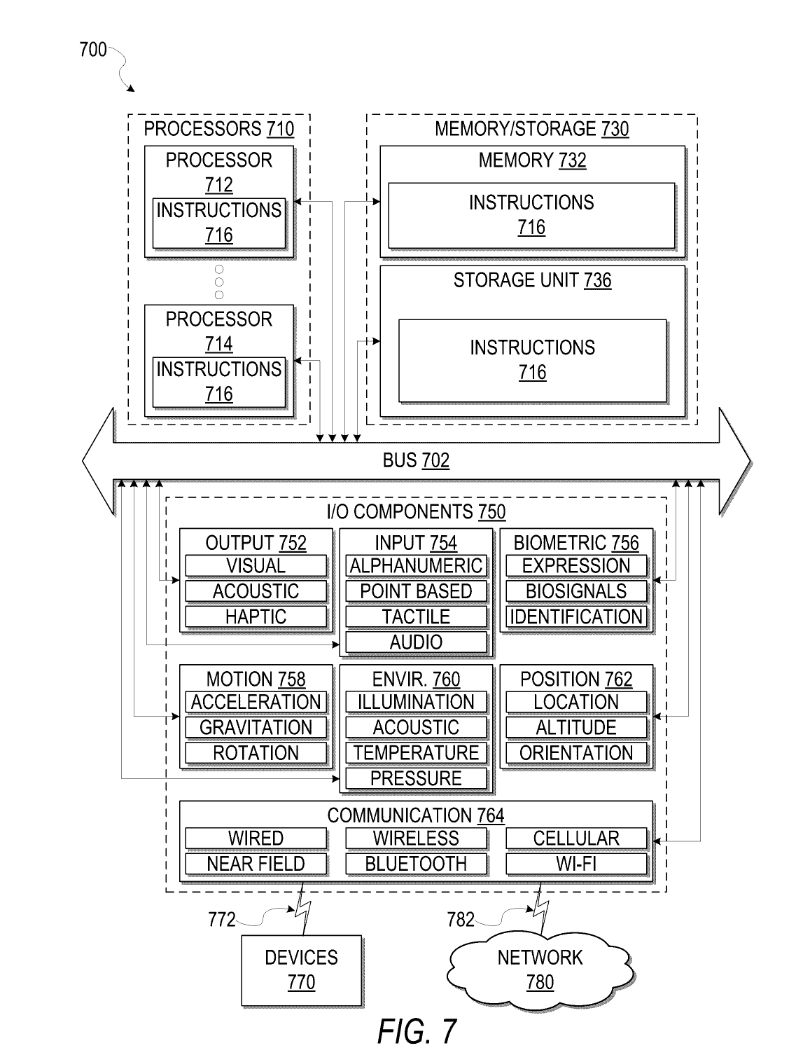

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the flow diagrams of FIGS. 3-5. Additionally, or alternatively, the instructions may implement one or more of the components of FIGS. 1-2. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A computer-implemented method for global object recognition comprising:
receiving, by one or more hardware processors, a plurality of context parameters that define a geographic search for an object to be located;
receiving, by the one or more hardware processors, a plurality of characteristics that define the object to be located;
retrieving, based on the plurality of context parameters, one or more images representing a geographic location;
selecting, from a plurality of image processing algorithms, a subset of image processing algorithms to be used in processing the retrieved one or more images;
processing the retrieved one or more images according to the selected subset of image processing algorithms to obtain a plurality of results, at least one result indicating whether the object was identified in a corresponding image; and
determining at least one confidence value representing whether the object was located in one or more of the retrieved one or more images based on the at least one result.

2. The computer-implemented method of claim 1, wherein the subset of image processing algorithms are selected based on the context parameters that define the geographic search.

3. The computer-implemented method of claim 1, wherein the subset of image processing algorithms are selected based on the plurality of characteristics that define the object to be located.

4. The computer-implemented method of claim 1, wherein determining the at least one confidence value includes applying a stochastic processor to the at least one result.

5. The computer-implemented method of claim 1, wherein the one or more images comprise a first plurality of images representing the geographic location and a second plurality of images representing the geographic location; and
the method further comprises removing the second plurality of images from the one or more images based on having processed the first plurality of images according to the selected subset of image processing algorithms.

6. The computer-implemented method of claim 1, further comprising:
generating a visualization of the at least one confidence value mapped to the geographic location corresponding to the at least one image.

7. The computer-implemented method of claim 1, further comprising:
implementing at least one image processing algorithm from the subset of image processing algorithms on at least one network node of a network node cluster in communication with the one or more hardware processors, the at least one network node configured to execute the at least one image processing algorithm on at least one image of the retrieved one or more images.

8. A system for global object recognition comprising:
a machine-readable medium storing computer-executable instructions; and
at least one hardware processor in communication with the machine-readable medium that, having executed the computer-executable instructions, performs a plurality of operations, the operations comprising:
receiving, by one or more hardware processors, a plurality of context parameters that define a geographic search for an object to be located;
receiving, by the one or more hardware processors, a plurality of characteristics that define the object to be located;
retrieving, based on the plurality of context parameters, one or more images representing a geographic location;
selecting, from a plurality of image processing algorithms, a subset of image processing algorithms to be used in processing the retrieved one or more images;
processing the retrieved one or more images according to the selected subset of image processing algorithms to obtain a plurality of results, at least one result indicating whether the object was identified in a corresponding image; and
determining at least one confidence value representing whether the object was located in one or more of the retrieved one or more images based on the at least one result.

9. The system of claim 8, wherein the at least one hardware processor selects the subset of image processing algorithms based on the context parameters that define the geographic search.

10. The system of claim 8, wherein the at least one hardware processor selects the subset of image processing algorithms on the plurality of characteristics that define the object to be located.

11. The system of claim 1, wherein determining the at least one confidence value includes applying a stochastic processor to the at least one result.

12. The system of claim 1, wherein the one or more images comprise a first plurality of images representing the geographic location and a second plurality of images representing the geographic location; and
the plurality of operations further comprise removing the second plurality of images from the one or more images based on having processed the first plurality of images according to the selected subset of image processing algorithms.

13. The system of claim 1, wherein the plurality of operations further comprise generating a visualization of the at least one confidence value mapped to the geographic location corresponding to the at least one image.

14. The system of claim 1, wherein the plurality of operations further comprise:
implementing at least one image processing algorithm from the subset of image processing algorithms on at least one network node of a network node cluster in communication with the at least one hardware processor, the at least one network node configured to execute the at least one image processing algorithm on at least one image of the retrieved one or more images.

15. A machine-readable medium having computer-executable instructions stored thereon that, when executed by at least one hardware processor, cause the at least one hardware processor to:
receive a plurality of context parameters that define a geographic search for an object to be located;
receive a plurality of characteristics that define the object to be located;
receive, based on the plurality of context parameters, one or more images representing a geographic location;
select, from a plurality of image processing algorithms, a subset of image processing algorithms to be used in processing the retrieved one or more images;
process the retrieved one or more images according to the selected subset of image processing algorithms to obtain a plurality of results, at least one result indicating whether the object was identified in a corresponding image; and
determine at least one confidence value representing whether the object was located in one or more of the retrieved one or more images based on the at least one result.

16. The machine-readable medium of claim 15, wherein the selection of the subset of image processing algorithms is based on the context parameters that define the geographic search.

17. The machine-readable medium of claim 15, wherein the selection of the subset of image processing algorithms is based on the plurality of characteristics that define the object to be located.

18. The machine-readable medium of claim 15, wherein the determination of the at least one confidence value includes applying a stochastic processor to the at least one result.

19. The machine-readable medium of claim 15, wherein the one or more images comprise a first plurality of images representing the geographic location and a second plurality of images representing the geographic location; and
the at least one hardware processor further removes the second plurality of images from the one or more images based on having processed the first plurality of images according to the selected subset of image processing algorithms.

20. The machine-readable medium of claim 15, wherein the at least one hardware processor further generates a visualization of the at least one confidence value mapped to the geographic location corresponding to the at least one image.

21. A computer-implemented method for global object recognition comprising:
receiving, by one or more hardware processors, a plurality of context parameters that define a search for an object to be located;
receiving, by the one or more hardware processors, a plurality of characteristics that define the object to be located;
retrieving, based on the plurality of context parameters, a plurality of source data;
selecting, from a plurality of processing algorithms, a subset of processing algorithms to be used in processing the retrieved one or more source data;
processing the retrieved plurality of source data according to the selected subset of processing algorithms to obtain a plurality of results, at least one result indicating whether the object was identified in a corresponding source data; and
determining at least one confidence value representing whether the object was located in one or more of the retrieved source data based on the at least one result.

22. The computer-implemented method of claim 21, wherein the method further comprises building one or more algorithm chains indicating the order in which the algorithms are to be executed.

23. The computer-implemented method of claim 22, wherein the one or more algorithm chains are built to increase overall processing speed by reducing the source data.

24. The computer-implemented method of claim 23, wherein the method further comprises at each said algorithm in the chain removing one or more source data based on having processed the plurality of source data according to said algorithm.

25. The computer-implemented method of claim 24, wherein the source data is an image.
